(19) United States
(12) Patent Application Publication
(10) Pub. No.: US 2009/0013509 A1
(43) Pub. Date: Jan. 15, 2009

(54) Clamp to hold an object inside a vessel

(76) Inventor: Kenneth Mark Busler, Dayton, OH (US)

Correspondence Address: KENNETH BUSLER, 610-A CORONA AVENUE, DAYTON, OH, 45419, US

(21) Appl. No.: 11/778,024

(22) Filed: Jul. 14, 2007

(51) Int. Cl. F16B 45/00

(52) U.S. Cl. 24/598.6; 24/20 CW; 24/545

(57) ABSTRACT

A clamp for holding shut and submerged a coffee filter containing coffee grounds or the like inside a vessel comprises one strand of wire formed such that an arc-shaped portion separates two arms. A first arm possesses a first jaw of the clamp. A second arm possesses a bent loop portion that functions as a second jaw of the clamp. The first jaw protrudes slightly through the second jaw when the clamp is in its free state. Pushing the first jaw farther through the second jaw expands a “window” in which an object can be placed, while bending the arc portion. After removing pressure from the arms, the clamp will release some of its stored mechanical energy, gripping and holding an object within the clamp's window portion by way of the remaining stored energy within the clamp and from the friction between the object and the clamp's window portion.

### BACKGROUND OF INVENTION

My clamp is novel and non-obvious in view of related art. Other devices for steeping coffee grounds rely on mechanical principles that differ entirely from the claims set forth in this application (cf. U.S. Pat. No. 5,806,409). The only device known to me that is similar to the invention claimed in this application is that of U.S. Pat. No. 4,569,105, invented by Joseph Weider.

Weider's invention is similar to the clamp claimed in this application only in that Weider's invention is formed from a single strand of wire, portions of which are shaped into handles, and relies on a spring-bias for clamping action. Weider's invention is, however, fundamentally different from the invention I claim in this application. Weider's device is essentially a coiled, torsion spring, where the portions of the wire strand extending beyond the coil are fashioned into handles. Weider's device is intended to hold discs securely on a barbell. Weider's device cannot be used for the applications intended and suggested for the clamp that I claim in this application. The claims set forth within this patent application specify that my invention is novel and non-obvious in view of related prior art.

The clamp claimed herein resulted from my desire to steep coffee grounds for one cup of coffee at a time, using a conventional, paper coffee filter. Once coffee grounds or the like are placed in a paper filter, the user can press the top portion of the filter together to enclose the grounds. The clamp can hold the filter shut and in place inside a mug or the like. A clamp of adequate weight will oppose the force of buoyancy against said filter so as to hold that portion of the filter containing the grounds submerged inside the mug.

With the clamp, a person does not need an electric coffee maker to brew coffee. The use of conventional coffee filters with the clamp to steep coffee grounds should prove much less expensive than doing so with manufactured coffee bags.

The clamp can be used also to brew other beverages, such as mulling wine or steeping tea leaves. Although the well-known tea ball (also called a tea infuser or tea egg) allows one to steep tea leaves and other things in hot water, the leaves or grounds must be removed from the tea ball by hand. The leaves or other substance can lodge in the holes of the tea ball. The clamp that I claim in this patent application, however, requires only that the user pull the used filter containing coffee grounds or the like from the clamp, then merely rinsing the clamp for clean up.

Additionally, the clamp can be used for other purposes not related to brewing any beverage. One example is to suspend a test-tube within a beaker so the test-tube does not touch the beaker.

### SUMMARY OF THE INVENTION

The intended use of the clamp is to grip and hold shut a paper filter containing coffee grounds or the like. Said clamp can be placed securely on the rim of a mug such that the portion of the filter containing the grounds hangs within the volume of the mug or like vessel. Thus, the coffee grounds can steep in hot water within the mug.

The clamp comprises a single strand of straight wire formed such that an arc-shaped portion separates two arms. A first arm comprises a first bent portion that functions as a first jaw of the clamp, a second bent portion to manipulate the clamp, and a third bent portion to guide placement of and secure the clamp onto a vessel. A second arm comprises a bent loop portion that functions as a second jaw of the clamp, said second jaw separating a terminal portion of the second arm from a straight portion of the second arm intermediate the second jaw and the arc. The first jaw protrudes slightly through the second jaw when the clamp is in its free state. When pressure is applied by hand to the arms of the clamp, the first jaw protrudes farther through the second jaw, expanding a “window” in which an object can be placed, while bending the arc portion. When pressure is removed from the arms, the clamp will release some of its stored mechanical energy, gripping and holding an object within the clamp's window portion by way of the remaining stored energy within the clamp and from the friction between said object and the clamp's window portion.

### DETAILED DESCRIPTION OF THE INVENTION

The clamp could be formed by plastic deformation of a single strand of straight, metal wire. Preferred materials include ductile metals such as brass, copper, and steel. Additionally, any of these metals could be electroplated or plastic-coated to prevent oxidation. Plastics, such as polypropylene, could be an only preferred material in applications where the object to be held possesses an average density such that the weight of the clamp does not help to keep the object submerged. For the particular purpose of steeping coffee grounds and the like, the most preferred material would be a straight, cylindrical, stainless steel wire of a gauge necessary to provide adequate weight to hold submerged in water inside a vessel a paper filter containing coffee grounds or the like. Surgical steel is the most preferred material for applications where the clamp would be used in a sterile environment. Once formed, the wire clamp would be annealed to repair any ductile fractures. Both ends of the wire would be beveled or rounded and ground smooth.

A preferred embodiment for a clamp that falls within the scope of my claims is formed from a single strand of straight, cylindrical, stainless steel wire with a ⅛-inch diameter wire. The wire is bent into 17 “angles” at 17 specific points, resulting in 18 straight “segments” (“segment 1” through “segment 18” in linear order). Said “angles” are generally angles, where each angle comprises two generally straight segments of wire. Naturally, these are not perfect angles with perfect vertices, but where the vertices might be small arcs. Ultimately, “segment 11” is formed into the shape of an arc.

To clarify, if a person were to bend a strand of straight metal wire so as to create an angle, then one of the two resulting segments is “segment 1.” The angle formed, which includes segment 1, is “angle 1.” The remainder of the wire will be bent at other points to create various other angles and segments. The next angle formed along the wire with no angles between said angle and angle 1 is “angle 2.” Once angle 2 exists, angle 1 can be described more specifically as comprising segment 1 and “segment 2” and angle 2 comprises segment 2 and the remainder of the wire strand. Therefore, in a clamp comprising eighteen segments within one strand of wire, segments 1 and 18 are terminal segments, separated by segments 2 through 17. Thus, each segment's number and each angle's number identify their respective positions in numerical order along the wire.

Segment 11 lies intermediate the ends of the wire. At some time in the formation of the clamp from said wire, segment 11 is formed into an arc. The first end of said wire is formed into a first arm. Said first arm comprises segments 12 through 18. A first bent portion of said first arm comprises segments 14 and 15 specifically to function as a first jaw of said clamp. A second bent portion of said first arm comprises segments 17 and 18 to be manipulated by hand. A third bent portion of said first arm comprises segments 12 and 13 to hook or rest the clamp on a vessel's rim, henceforth called a first “catch.”

The second end of said wire is formed into a second arm. Said second arm comprises segments 1 through 10. A bent loop portion, lying intermediate the ends of said second arm functions as a second jaw of said clamp. Said second jaw comprises segments 3 through 9 and a first portion of segment 10. Said first portion of segment 10 is the portion of segment 10 that touches segments 4, 5, and 9, but touches no other segments. Segments 5 and 8 limit the extent to which said first jaw can be pushed through said second jaw.

A first end of said second arm, lying intermediate segment 11 and said second jaw, comprises a second portion of segment 10. Said second portion of segment 10 is the portion of segment 10 that touches only segment 11. A second catch comprises said first end of said second arm and segment 5. A second end of said second arm, to be used as a handle, comprises segments 1 and 2. Said second end of said second arm, is to rest on the rim of a vessel. In some versions of the clamp, some portion of said second end of said second arm might possess a bent portion to function as a third catch.

I will specify said preferred embodiment for a clamp formed from a single strand of straight, cylindrical, stainless steel wire with a ⅛-inch diameter, comprising 18 segments by stating the location of the one-dimensional central axis of each segment. Locations are stated using Cartesian coordinates (X, Y, Z), where each axis of the grid is divided into ⅛-inch units. The central axis of segment 1 spans from 0, 0, 0 to 0, 8, 0. The central axis of segment 2 spans from 0, 8, 0 to 4, 12, 0. The central axis of segment 3 spans from 4, 12, 0 to −2, 18, 0. The central axis of segment 4 spans from −2, 18, 0 to 6, 26, 0. The central axis of segment 5 spans from 6, 26, 0 to 6, 26, −3. The central axis of segment 6 spans from 6, 26, −3 to −1.5, 18.5, −3. The central axis of segment 7 spans from −1.5, 18.5, −3 to 4.5, 12.5, −3. The central axis of segment 8 spans from 4.5, 12.5, −3 to 4.5, 12.5, 0. The central axis of segment 9 spans from 4.5, 12.5, 0 to −0.5, 18, 0. The central axis of segment 10 spans from −0.5, 18, 0 to 9.2, 27.8, 0. Segment 11 is in the shape of an arc, such that its central axis is an arc of a circle with a 3-inch diameter. The end points of the arc-shaped central axis of segment 11 are 9.2, 27.8, 0 and −8.5, 28.5, 0. The central axis of segment 12 spans from −8.5, 28.5, 0 to −6, 26, 0. The central axis of segment 13 spans from −6, 26, 0 to −6, 26, −1.5. The central axis of segment 14 spans from −6, 26, −1.5 to 2, 18, −1.5. The central axis of segment 15 spans from 2, 18, −1.5 to −6, 10, −1.5. The central axis of segment 16 spans from −6, 10, −1.5 to −8, 12, −1.5. The central axis of segment 17 spans from −8, 12, −1.5 to −6, 14, −1.5. The central axis of segment 18 spans from −6, 14, −1.5 to −6, 18, −1.5.

Grind the two tips of the wire clamp so they are smooth and have a beveled or rounded appearance. Likewise, grind any other portion of the clamp, so that the clamp is smooth all over its surface. Heat-treat the clamp to repair any ductile fractures.

By applying pressure to both arms, the user bends the arc, while expanding the area between the jaws. The user can insert an object into the area between the jaws and then remove pressure, allowing the area between the jaws to contract toward its default size. So long as the object to be clamped is of adequate girth and strength, the pressure exerted by the stored energy in the clamp and the friction of the object against angles 6, 9, and 14 will hold the object in place. The ideal points of pressure for the user to expand area between the jaws are angle 17 and segment 8.

This example of a clamp, which falls within the scope of my claims, should be suitable for holding closed and submerged a paper filter containing coffee grounds or like within a standard size mug, containing hot water. The clamp might prove to be the most economical way of producing a cup of coffee, since the user need only conventional paper filters, coffee grounds, and the ability to boil water, and one vessel of appropriate size to accommodate a clamp of commensurate dimensions and weight.

The clamp could be used, however, for applications unrelated to brewing coffee. The clamp can hold other objects within the containing space of other vessel types, such as holding a test-tube within a beaker. Therefore, the above description and examples should not be construed as limitations on the scope of the invention. Many other variations of the clamp are possible. The claims and their legal equivalents determine the scope of the invention.

What is claimed is:

1) A clamp formed from one strand of wire for holding an object within a vessel, said clamp comprising:
an arc formed intermediate the ends of a wire;
a first end of said wire forming a first arm;
said first arm comprising (a) a first bent portion, said first bent portion being a first jaw of said clamp, said first jaw lying on a plane different from and not perpendicular to the plane on which said arc lies, (b) a second bent portion for manipulating the clamp by hand, and (c) a third bent portion to hook or rest the clamp on a vessel's rim, said third bent portion lying on a plane intersecting the plane on which said arc lies;
a second end of said wire forming a second arm;
said second arm comprising (a) a bent loop portion formed intermediate the ends of said second arm, said bent loop being a second jaw, through which said first jaw protrudes partially when the clamp is at rest, (b) a first end of said second arm intermediate said arc and said second jaw, (c) a second end of said second arm to be used as a handle.

2) A clamp according to claim 1, wherein said second end of said second arm possesses a bent portion to hook or rest the clamp on a vessel's rim, said bent portion of said second end of said second arm lying on a plane intersecting the plane on which said arc lies.

3) A clamp according to claim 1, wherein said arc is a straight segment of wire.

4) A clamp according to claims 1 through 3, wherein said clamp is made from stainless steel.

5) A clamp according to claims 1 through 3, wherein said clamp is made from surgical steel.

6) A clamp according to claims 1 through 5, wherein the terminal ends of said clamp are beveled or rounded and ground smooth.

7) A clamp according to claim 1 through 3, wherein said clamp is made from a material other than metal, such as injection-molded plastic.
